(19) United States
(12) Patent Application Publication
(10) Pub. No.: US 2005/0004744 A1
(43) Pub. Date: Jan. 6, 2005

(54) Vehicle distance and speed control method and system

(76) Inventors: Thomas Dieckmann, Pattensen (DE); Frank Zielke, Barsinghausen (DE)

Correspondence Address: KRAMER LEVIN NAFTALIS & FRANKEL LLP;INTELLECTUAL PROPERTY DEPARTMENT, 919 THIRD AVENUE, NEW YORK, NY, 10022, US

(21) Appl. No.: 10/849,489

(22) Filed: May 19, 2004

(30) Foreign Application Priority Data
May 30, 2003 (DE) 103 24 725.4

(51) Int. Cl. B60K 31/00

(52) U.S. Cl. 701/96; 701/93; 180/170

(57) ABSTRACT

A system and method for controlling overtaking by a vehicle equipped with a distance/speed control device traveling a multi-lane roadway of one or more vehicles traveling ahead. The controlled vehicle tracks a vehicle ahead, ascertains the lane in which the vehicle ahead is traveling and, on the basis of the lane and speed and/or distance of the vehicle ahead relative to the controlled vehicle, the speed of the controlled vehicle is adjusted to permit overtaking in the passing lane if the vehicle ahead is traveling in a non-passing lane, and overtaking in a non-passing lane is not permitted if the vehicle ahead is traveling in a passing lane. If a line of vehicles traveling ahead is recognized, overtaking in the non-passing lane is permitted, depending on location-specific traffic rules, the speed of the controlled vehicle being adjusted as appropriate to overtake the line of vehicles.

### BACKGROUND OF THE INVENTION

The present invention relates to a vehicle distance and speed control system and method for controlling overtaking from a non-passing lane.

EP 07 16 949 B1 describes a conventional vehicle cruise-control system capable of determining whether the closest vehicle traveling ahead of the controlled vehicle is driving in the same lane or in an adjacent lane. If the closest vehicle traveling ahead is driving in an adjacent, slower lane and is moving more slowly than the controlled vehicle, the cruise-control system permits overtaking of the vehicle traveling ahead. If the closest vehicle traveling ahead is driving in an adjacent, faster lane and is moving faster than the controlled vehicle, the cruise-control system does not permit overtaking of the vehicle ahead. While, therefore, in principle, the cruise-control system described in EP 07 16 949 B1 permits overtaking from the faster, passing lane (left lane in the United States and Germany, for example) and prevents such overtaking from the slower, non-passing lane (right lane in the United States and Germany, for example), it accounts for traffic situations and legal regulations to only a limited extent.

Accordingly, it is desired to provide a vehicle distance and speed control system and method that overcome the disadvantages associated with conventional systems and methods and that assist the driver in initiating an overtaking maneuver from a non-passing lane and that take into account a wide variety of different traffic situations and traffic rules.

### SUMMARY OF THE INVENTION

Generally speaking, in accordance with the present invention, a vehicle distance and speed control system and method for controlling overtaking from a non-passing lane are provided which improve over prior art systems and methods.

According to a preferred embodiment of the improved vehicle distance and speed control system and method according to the present invention, overtaking from a non-passing lane (i.e., a lane in which overtaking is normally not permitted; for example, overtaking on the right from an adjacent right lane is generally prohibited in the United States) is permitted or prevented depending on the traffic situation in the lanes, on the speeds of vehicles sensed in the lanes and on the traffic rules for the relevant jurisdiction (e.g., country, state etc.). For this purpose, the inventive vehicle distance and speed control system contains a program expansion by means of which it can ascertain whether a vehicle traveling ahead in a lane with respect to which overtaking and passing is permitted (for example, an adjacent left lane in the United States and in Germany) is traveling alone or in a grouping of vehicles, and in this way if a single vehicle is recognized, overtaking from the non-passing lane is prevented and, if a line of vehicles is recognized, depending on jurisdiction-specific traffic rules, overtaking from the non-passing lane is permitted, and, if necessary, the speed of the controlled vehicle is adjusted to a speed appropriate for overtaking the line of vehicles.

According to another embodiment of the inventive vehicle distance and speed control system and method, overtaking of a line of vehicles from a non-passing lane is permitted if the speed of the line of vehicles does not exceed a predetermined limit value.

The distance and speed control system according to the present invention is preferably constructed and arranged such that, if the vehicle driver's desire to overtake another vehicle is recognized, an overtaking function is activated which is implemented by an appropriate program expansion of the distance and speed control system.

The speed appropriate for overtaking a line of vehicles from a non-passing lane is preferably calculated as a function of the distance and/or of the speed relative to the line of vehicles.

A line of vehicles is recognized by the fact that several vehicles traveling ahead are moving at approximately the same speed.

Accordingly, it is an object of the present invention to provide an improved vehicle distance and speed control system and method that assist the driver in initiating an overtaking maneuver from a non-passing lane and that take into account a wide variety of different traffic situations and jurisdiction-specific traffic rules.

Still other objects and advantages of the present invention will in part be obvious and will in part be apparent from the specification.

The present invention accordingly comprises the various steps and the relation of one or more of such steps with respect to each of the others, and embodies features of construction, combinations of elements, and arrangement of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description taken in connection with the accompanying drawings in which:

FIG. 1 depicts the sensing range of a vehicle equipped with a distance and speed control system according to the present invention traveling on a three-lane roadway;

FIG. 2 is a block diagram of a distance and speed control system constructed and arranged in accordance with a preferred embodiment of the present invention; and

FIG. 3 is a flow diagram showing the process flow of a method for controlling vehicle overtaking from a non-passing lane according to a preferred embodiment of the present invention.

### DETAILED DESCRIPTION OF THE PREFERRED EMBODIMENTS

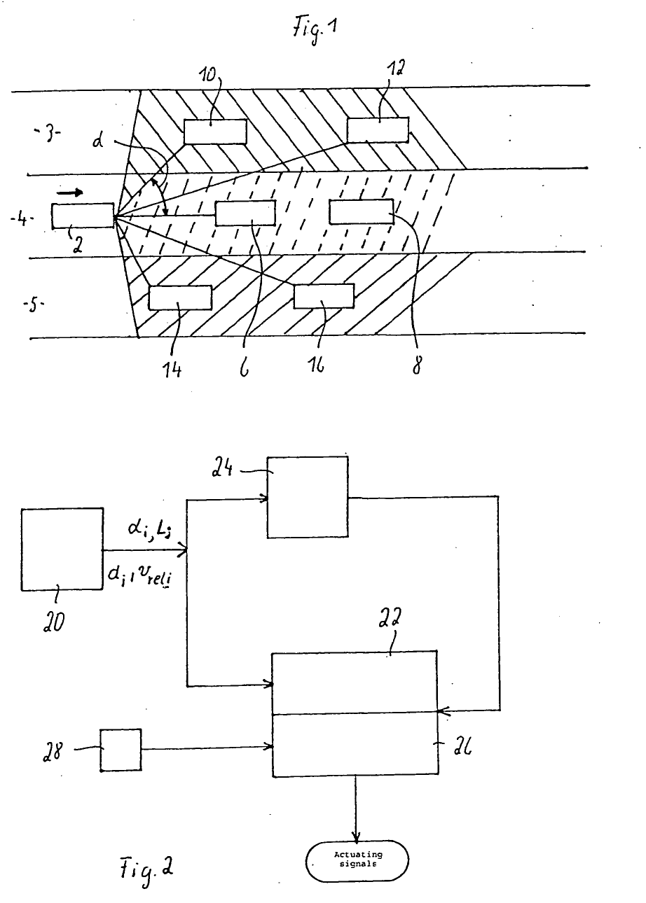

Referring now to the drawing figures, where like and corresponding parts are denoted by like reference numerals, FIG. 1 depicts sensing ranges of a vehicle equipped with a distance and speed control system according to the present invention. Vehicle 2 is shown traveling in center lane 4 of a highway having three lanes 3, 4, 5. Traveling ahead of vehicle 2 are other vehicles 6, 8 in the same center lane, vehicles 10, 12 in the adjacent left lane and vehicles 14, 16 in the adjacent right lane. The adjacent left lane represents the passing lane and the adjacent right lane represents the non-passing lane relative to vehicle 2. The sensing ranges in the individual lanes are represented in FIG. 1 by different shading.

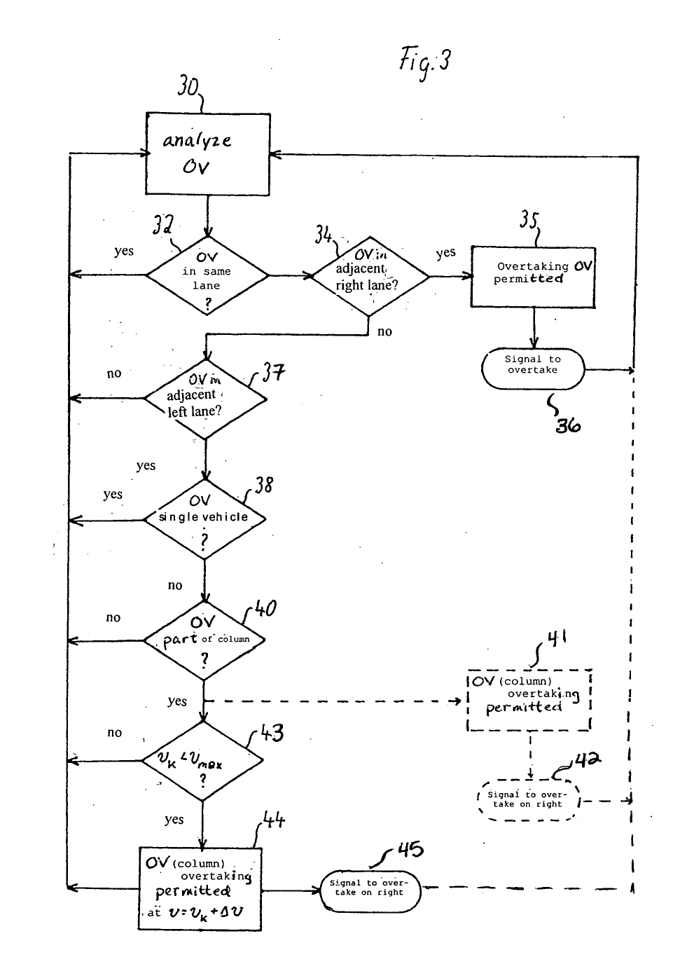

FIG. 2 is a block diagram depicting a distance and speed control system for controlling vehicle overtaking maneuvers constructed and arranged in accordance with a preferred embodiment of the present invention. A sensor system 20, preferably a radar system, delivers information about distance dᵢ and relative speed vᵣₑₗ_{_{—}}ᵢ between vehicle 2 and the other vehicles 6, 8, 10, 12, 14 and 16 traveling in lanes 3, 4, 5.

Since sensor system 20 has only limited sensing range, the number of vehicles that can be sensed is limited to a particular maximum number. Vehicle 6, which is the closest vehicle traveling directly ahead, is selected as the target vehicle and entered as the reference for the distance and speed control system.

The measured distances dᵢ and speeds Vᵣₑₗ_{_{—}}ᵢ are transmitted to a distance and speed control device 22 for evaluation and generation of control variables for distance and speed control of controlled vehicle 2. In addition, sensor system 20 delivers information on the angles αᵢ at which the other vehicles are situated relative to vehicle 2 and on the number of vehicles traveling ahead in the respective lane-specific sensing range.

On the basis of the angle information, a device 24 ascertains the lanes 3, 4 and 5 associated with sensed vehicles 6, 8, 10, 12, 14 and 16. The lane information Lⱼ (index j denoting “same lane”, “adjacent left lane”, “adjacent right lane”) is supplied to distance and speed control device 22, which is equipped with an overtaking-function module implemented by a program expansion 26 as part of the distance and speed control device 22.

In the overtaking-function module 26, the information concerning the lanes and relative speeds of the vehicles in the same lane as controlled vehicle 2 and of the vehicles in adjacent lanes as well as concerning the number of vehicles in the respective sensing range is evaluated, taking stored jurisdiction-specific traffic rules into consideration, for the purpose of determining whether overtaking from a non-passing lane can be permitted.

In a further embodiment of the present invention, it can also be provided that the jurisdiction-specific data resident in the overtaking-function module or in program expansion 26 can be called up by identifying the jurisdiction by means of a global positioning system (GPS). In this connection, it can also be provided that the data are automatically updated via an Internet link.

Furthermore, the vehicle driver can communicate an intention to overtake another vehicle or vehicles to overtaking-function module 26, for example by actuating turn signal 28, the intention being evaluated in the overtaking-function module 26 on the basis of the available data.

Actuation of the turn signal may also signify an intention merely to change lanes without overtaking. By appropriate criteria, such as the speed of the vehicle relative to the vehicle traveling ahead, the difference between a mere lane change and the overtaking function can be recognized. For this purpose, the program checks whether the controlled vehicle is building up a differential speed relative to the vehicle traveling ahead. If both vehicles are driving at approximately the same speed, there is no intention to overtake. If a positive differential speed is observed, an intention to overtake does exist.

The method for controlling vehicle overtaking from a non-passing lane in accordance with a preferred embodiment of the present invention will be explained in greater detail hereinafter on the basis of the flow diagram according to FIG. 3.

At the beginning of the inventive process (step 30) depicted in FIG. 3, it is assumed that controlled vehicle 2 is tracking, by means of distance and speed control device 22, a vehicle traveling ahead of it in a lane, and that the intention exists to overtake the vehicle traveling ahead (referred to hereinafter as overtaken vehicle OV).

In step 32, the program queries whether overtaken vehicle OV is traveling in the same lane as controlled vehicle 2. If overtaken vehicle OV is not traveling in the same lane as controlled vehicle 2, the program checks, in step 34, whether overtaken vehicle OV is traveling in an adjacent lane with respect to which overtaking and passing by controlled vehicle 2 is permitted (e.g., an adjacent right lane in the case of traffic driving on the right (FIG. 3), or an adjacent left lane in the case of traffic driving on the left).

If overtaken vehicle OV is traveling in an adjacent lane with respect to which overtaking and passing by controlled vehicle 2 is permitted, the program permits overtaking of overtaken vehicle OV and generates a corresponding overtake signal (steps 35 and 36). Thereafter, the program returns to step 30.

If overtaken vehicle OV is not traveling in an adjacent lane with respect to which overtaking and passing by controlled vehicle 2 is permitted, the program checks, in step 37, whether the vehicle to be overtaken is traveling in an adjacent lane with respect to which overtaking and passing by vehicle 2 is not permitted (e.g., an adjacent left lane in the case of traffic driving on the right (FIG. 3), or an adjacent right lane in the case of traffic driving on the left). If this is not the case, the program returns to step 30.

If overtaken vehicle OV is traveling in an adjacent lane with respect to which overtaking and passing by vehicle 2 is not permitted, the program proceeds to step 38, in which it then checks whether overtaken vehicle OV is a single vehicle traveling alone.

If overtaken vehicle OV is a single vehicle traveling alone, the program returns to step 30 and does not generate a signal to overtake. If overtaken vehicle OV is not a single vehicle traveling alone, the program queries, in step 40, whether the vehicle to be overtaken is part of a line of vehicles.

If overtaken vehicle OV is not part of a line of vehicles, the program returns to step 30 without generating a signal to overtake. If overtaken vehicle OV is part of a line of vehicles the program will permit overtaking of the line of vehicles, depending on applicable jurisdiction-specific traffic rules, and it generates an appropriate overtake signal (represented by broken lines in FIG. 3) to overtake on the right (steps 41 and 42) followed by a return to step 30.

Alternatively, taking, for example, German traffic rules into consideration, the program can check, in step 43, whether the speed v_{K} of the line of vehicles is less than a predetermined maximum speed v_{K} (which is currently 80 km/h in Germany, for example). If the speed v_{K} of the vehicle column is not less than the predetermined maximum speed vₘₐₓ, the program returns to step 30 without generating an overtake signal. If the speed v_{K} of the vehicle column is less than the predetermined maximum speed vₘₐₓ, the program permits overtaking—depending, as the case may be, on jurisdiction-specific traffic rules, with a speed v_{O}, which exceeds the convoy speed v_{K} by a predetermined value Δv (currently 20 km/h in Germany, for example)—and generates a corresponding overtake signal (steps 44 and 45). Thereafter, the program returns to step 30.

For the case that the driver of vehicle 2 indicates a desire to overtake, it can be provided that the required distance of controlled vehicle 2 relative to the line of vehicles to be overtaken will be set temporarily to a predetermined minimum distance.

If an overtaking maneuver is aborted or has been completed, or if merely a lane change has been executed, the program returns to normal distance and speed control.

Accordingly, the present invention provides an improved vehicle distance and speed control system and method that assist the driver in overtaking and passing vehicles traveling ahead while taking into account different traffic situations and location-specific traffic rules.

It will thus be seen that the objects set forth above, among those made apparent from the preceding description, are efficiently attained, and since certain changes may be made in carrying out the above method and in the constructions set forth without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1. A method for controlling vehicle distance and speed in a controlled vehicle traveling on a roadway having a plurality of lanes, comprising the steps of tracking at least one vehicle to be overtaken traveling ahead of said controlled vehicle using a vehicle distance and speed control device of said controlled vehicle, ascertaining in which one of said plurality of lanes said at least one vehicle to be overtaken is traveling, when said at least one vehicle to be overtaken is traveling in a lane adjacent to said controlled vehicle with respect to which overtaking and passing of said at least one vehicle to be overtaken by said controlled vehicle is permitted based on applicable traffic rules, sensing at least one of the speed of said at least one vehicle to be overtaken and the distance between said controlled vehicle and said at least one vehicle to be overtaken and, based thereon, automatically adjusting the speed of said controlled vehicle to overtake and pass said at least one vehicle to be overtaken, and when said at least one vehicle to be overtaken is traveling in a lane adjacent to said controlled vehicle with respect to which overtaking and passing of said at least one vehicle to be overtaken by said controlled vehicle is not permitted based on applicable traffic rules, ascertaining whether said at least one vehicle to be overtaken is part of a line of vehicles, when said at least one vehicle to be overtaken is part of a line of vehicles and when applicable traffic rules permit, automatically adjusting the speed of said controlled vehicle to overtake and pass said line of vehicles.

2. The method according to claim 1, wherein a line of vehicles is recognized when said at least one vehicle to be overtaken includes a plurality of vehicles each of which is moving at substantially the same speed.

3. The method according to claim 1, wherein said step of adjusting the speed of said controlled vehicle to overtake and pass said line of vehicles is effected when the speed of said line of vehicles is less than a predetermined speed.

4. The method according to claim 1, wherein the step of automatically adjusting the speed of said controlled vehicle to overtake and pass said line of vehicles includes calculating a speed sufficient for said controlled vehicle to overtake and pass said line of vehicles as a function of at least one of the distance and the relative speed of said line of vehicles.

5. The method according to claim 4, wherein said speed sufficient for said controlled vehicle to overtake and pass said line of vehicles is limited to a predetermined difference value relative to the speed of said line of vehicles.

6. The method according to claim 4, wherein the step of automatically adjusting the speed of said controlled vehicle to overtake and pass said line of vehicles is not effected when said speed sufficient for said controlled vehicle to overtake and pass said line of vehicles exceeds a predetermined maximum value.

7. The method according to claim 4, further comprising the steps of recognizing a vehicle overtaking maneuver initiated by a driver of said controlled vehicle and temporarily resetting a required distance of said controlled vehicle relative to said line of vehicles to a predetermined minimum distance.

8. The method according to claim 1, wherein said step of tracking at least one vehicle to be overtaken traveling ahead of said controlled vehicle is terminated when at least one of (i) a vehicle overtaking maneuver initiated by a driver of said controlled vehicle is aborted and (ii) said vehicle overtaking maneuver initiated by said driver of said controlled vehicle is completed and (iii) said controlled vehicle executes a lane change.

9. The method according to claim 1, further comprising the steps of recognizing a vehicle overtaking maneuver initiated by a driver of said vehicle and activating an overtaking function implemented by a program expansion of said vehicle distance and speed control device in response thereto.

10. The method according to claim 9, wherein said applicable traffic rules are resident in said program expansion of said vehicle distance and speed control system.

11. The method according to claim 10, wherein said applicable traffic rules for a particular jurisdiction are accessed automatically through identification of said jurisdiction using a global positioning system.

12. The method according to claim 11, wherein said applicable traffic rules are automatically updated via an Internet link.

13. A system for controlling vehicle distance and speed in a controlled vehicle traveling on a roadway having a plurality of lanes, comprising a vehicle distance and speed control device of said controlled vehicle, means associated with said vehicle distance and speed control device for tracking at least one vehicle to be overtaken traveling ahead of said controlled vehicle, means for ascertaining in which one of said plurality of lanes said at least one vehicle to be overtaken is traveling, means for sensing at least one of the speed of said at least one vehicle to be overtaken and the distance between said controlled vehicle and said at least one vehicle to be overtaken and, based thereon, automatically adjusting the speed of said controlled vehicle to overtake and pass said at least one vehicle to be overtaken when said at least one vehicle to be overtaken is traveling in a lane adjacent to said controlled vehicle with respect to which overtaking and passing of said at least one vehicle to be overtaken by said controlled vehicle is permitted based on applicable traffic rules, and means for ascertaining whether said at least one vehicle to be overtaken is part of a line of vehicles, and when said at least one vehicle to be overtaken is part of a line of vehicles and when applicable traffic rules permit, automatically adjusting the speed of said controlled vehicle to overtake and pass said line of vehicles when said at least one vehicle to be overtaken is traveling in a lane adjacent to said controlled vehicle with respect to which overtaking and passing of said at least one vehicle to be overtaken by said controlled vehicle is not permitted based on applicable traffic rules.

14. The system according to claim 13, wherein a line of vehicles is recognized when said at least one vehicle to be overtaken includes a plurality of vehicles each of which is moving at substantially the same speed.

15. The system according to claim 13, wherein said means for adjusting the speed of said controlled vehicle to overtake and pass said line of vehicles is actuated when the speed of said line of vehicles is less than a predetermined speed.

16. The system according to claim 13, wherein said means for automatically adjusting the speed of said controlled vehicle to overtake and pass said line of vehicles includes means for calculating a speed sufficient for said controlled vehicle to overtake and pass said line of vehicles as a function of at least one of the distance and the relative speed of said line of vehicles.

17. The system according to claim 16, wherein said speed sufficient for said controlled vehicle to overtake and pass said line of vehicles is limited to a predetermined difference value relative to the speed of said line of vehicles.

18. The system according to claim 16, wherein said means for automatically adjusting the speed of said controlled vehicle to overtake and pass said line of vehicles is not actuated when said speed sufficient for said controlled vehicle to overtake and pass said line of vehicles exceeds a predetermined maximum value.

19. The system according to claim 16, further comprising means for recognizing a vehicle overtaking maneuver initiated by a driver of said controlled vehicle and temporarily resetting a required distance of said controlled vehicle relative to said line of vehicles to a predetermined minimum distance.

20. The system according to claim 13, further comprising means for recognizing a vehicle overtaking maneuver initiated by a driver of said vehicle and activating an overtaking function implemented by a program expansion of said vehicle distance and speed control device in response thereto.

21. The system according to claim 20, wherein said program expansion of said vehicle distance and speed control system is adapted to store said applicable traffic rules.

22. The system according to claim 21, further comprising means for accessing said applicable traffic rules of a particular jurisdiction automatically through identification of said jurisdiction using a global positioning system.

23. The system according to claim 22, further comprising an Internet link for automatically updating said applicable traffic rules.
